(19) United States
(12) Patent Application Publication
(10) Pub. No.: US 2013/0340716 A1
(43) Pub. Date: Dec. 26, 2013

(54) CLOSED LOOP CONTROL FUEL INJECTION METHOD

(71) Applicant: HYUNDAI MOTOR COMPANY, Seoul (KR)

(72) Inventor: Changyeol Choi, Yongin-si (KR)

(73) Assignee: Hyundai Motor Company, Seoul (KR)

(21) Appl. No.: 13/678,196

(22) Filed: Nov. 15, 2012

(30) Foreign Application Priority Data
Jun. 20, 2012 (KR) 10-2012-0066208

(51) Int. Cl. F02M 51/06

(52) U.S. Cl. CPC F02M 51/06
USPC 123/478

(57) ABSTRACT

A closed loop control fuel injection method allows an injection amount and injection timing to be obtained, in such a way that an HRR (Heat Release Rate) is calculated from a combustion pressure signal of a combustion pressure sensor after a related pilot fuel amount is injected in a state in which an engine is warmed up, and to be adjusted according to command values, thereby removing inaccuracy of closed loop calibration and risks due to the excess of EM control caused when simply using a combustion pressure diagram, through predefined stable conditions.

### CROSS-REFERENCE(S) TO RELATED APPLICATIONS

The present application claims priority of Korean Patent Application Number 10-2012-0066208 filed Jun. 20, 2012, the entire contents of which application is incorporated herein for all purposes by this reference.

### BACKGROUND OF INVENTION

1. Field of Invention

The present invention relates to a fuel injection system, and, particularly, to a closed loop control fuel injection method for measuring an HRR (Heat Release Rate), injection timing, and an injection amount through predefined stable conditions, thereby removing risks due to the excess of EM (emission) control caused when simply using a combustion pressure diagram.

2. Description of Related Art

In general, when an injector injects fuel into a combustion chamber in a direct injection manner, a fuel injection timing point may be variously determined regardless of behavior of an air intake valve, unlike a port injection manner.

Generally, accurate and effective control for the fuel injection timing point of the injector is absolutely required to satisfy increased fuel efficiency and EM (emission) control of an internal combustion engine, and thus closed loop control for the fuel injection timing point should be applied to the injector, instead of open loop control for the fuel injection timing point.

When the closed loop control for the fuel injection timing point is executed at the injector, the injector injects fuel and then allows for engine RPM (revolutions per minute) to readjust the fuel injection timing point. Accordingly, it may be possible to properly cope with the increased fuel efficiency and EM control of the engine.

Meanwhile, it is required that the readjustment of the fuel injection timing point is optimally selected to be adapted for a variety of vehicle conditions in the closed loop manner, but optimal combustion conditions vary with air temperature and air pressure, and cooling water temperature and engine oil temperature, respectively.

Therefore, the readjustment of the fuel injection timing point executed in the closed loop manner has limitations on selection of all optimal conditions to be adapted for a variety of vehicle conditions.

In particular, the accurate control of pilot injection is the most important factor of NVH (Noise, Vibration, and Harshness) in a diesel engine. Accordingly, if the pilot injection is not accurate, ignition delay is inaccurately controlled, thereby causing unstable combustion control of main injection. As a result, NVH and EM may be deteriorated.

In view of this, a method using a combustion pressure diagram of each cylinder, for example, may be applied to the control of the fuel injection timing point executed in the closed loop manner. This is a method of calculating (main) injection timing and an injection amount from the maximum combustion pressure after a top dead center and then adjusting the injection timing and injection amount of the optimal conditions based on the same.

Such a method, however, has complexity of calculation and significant errors in calculation. As a result, there is a problem of exceeding EM control since it is difficult to be injected in the closed loop control manner in a vehicle transient state.

Particularly, when an inaccurate combustion pressure diagram is used to control the injection timing and the injection amount, closed loop calibration may be inaccurately caused with respect to desired deviations, such as a production deviation and an aging deviation, of the injector.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a closed loop control fuel injection method capable of allowing an injection amount and injection timing to be obtained, in such a way that an HRR (Heat Release Rate) is calculated from a combustion pressure signal of a combustion pressure sensor after a related pilot fuel amount is injected in a state in which an engine is warmed up, and to be adjusted according to command values, thereby removing inaccuracy of closed loop calibration and risks due to the excess of EM control caused when simply using a combustion pressure diagram, through predefined stable conditions.

Various aspects of the present invention provide for a closed loop control fuel injection method including performing closed loop control of injector fuel injection classified into pilot injection and main injection if it is determined that an engine is a warm-up state and a fuel cut state, wherein the performing closed loop control of injector fuel injection includes performing the pilot injection in such a way that a fuel amount related to the pilot injection of the fuel injection is injected, an HRR (Heat Release Rate) together with a combustion pressure diagram are calculated by a combustion pressure signal detected from a combustion pressure sensor in a state of classifying rail pressures into a plurality of stages, an HRR height (H), an injection amount, and injection timing, which are obtained from the HRR, are compared with target values, and the HRR height (H), the injection amount, and the injection timing are controlled to be increased or decreased according to the target values, and performing the main injection, when the conditions of the pilot injection are released, in such a way that an HRR together with a combustion pressure diagram are calculated by a combustion pressure signal detected from a combustion pressure sensor in a state of classifying rail pressures into a plurality of stages, an HRR height (H), an injection amount, and injection timing, which are obtained from the HRR, are compared with target values, and the HRR height (H), the injection amount, and the injection timing are controlled to be increased or decreased according to the target values.

The warm-up state of the engine may be a case in which a cooling water temperature of the engine is above 90 degrees, the fuel cut may be generated during coast driving, and air temperature and air pressure may be above 20 degrees and 950 mbar atmosphere pressure, respectively.

The rail pressures may be classified into a 300 bar rail pressure, a 600 bar rail pressure, a 900 bar rail pressure, a 1200 bar rail pressure, a 1600 bar rail pressure, and a maximum rail pressure.

When all the pilot injection and the main injection are performed, each value for the HRR height (H), the injection amount, and the injection timing may be stored so that the stored value is used as a value just before, when the closed loop control of the injector fuel injection is executed again, being executed again.

Various aspects of the present invention provide for a closed loop control fuel injection method including identifying conditions so that closed loop control conditions of injector fuel injection classified into pilot injection and main injection are determined in a state in which an engine is a warm-up state and a fuel cut state, preparing pilot control so that, if the closed loop control conditions are satisfied, a fuel amount related to the pilot injection is injected, a combustion pressure diagram is calculated from a combustion pressure signal of a combustion pressure sensor with respect to a rail pressure 1 classified into a plurality of stages, an HRR diagram is derived from the combustion pressure signal, and an HRR height 1 (H), an injection amount 1, and injection timing 1 are calculated from the same, determining pilot control so that, under the same conditions, a rail pressure 2, an HRR height 2, an injection amount 2, and injection timing 2, which are increased or decreased values of the rail pressure 1, the HRR height 1 (H), the injection amount 1, and the injection timing 1, respectively, are calculated, and the values are compared with reference values (ref) according to engine RPM and an engine load, executing pilot control so that the HRR height 2, the injection amount 2, and the injection timing 2 are increased or decreased and calibrated to correspond to the reference values (ref) so as to determine target values, and the closed loop control is performed according to the target values, changing injection so that if rail pressures checked when pilot injection close loop control is executed exceed a set maximum rail pressure, the pilot injection is stopped and main injection close loop control is executed, preparing main control so that, if the main injection close loop control is executed, a fuel amount related to the main injection is injected, a combustion pressure diagram is calculated from a combustion pressure signal of a combustion pressure sensor with respect to a new rail pressure 1 classified into a plurality of stages, an HRR diagram is derived from the combustion pressure signal, and a new HRR height 1 (H), a new injection amount 1, and new injection timing 1 are calculated from the same, determining main control so that, under the same conditions, a new rail pressure 2, a new HRR height 2, a new injection amount 2, and new injection timing 2, which are increased or decreased values of the new rail pressure 1, the new HRR height 1 (H), the new injection amount 1, and the new injection timing 1, respectively, are calculated, and the values are compared with new reference values (ref) according to engine RPM and an engine load, and executing main control so that the new HRR height 2, the new injection amount 2, and the new injection timing 2 are increased or decreased and calibrated to correspond to the new reference values (ref) so as to determine target values, and the closed loop control is performed according to the target values.

The warm-up state of the engine may be a case in which a cooling water temperature of the engine is above 90 degrees, the fuel cut may be generated during coast driving, and air temperature and air pressure may be above 20 degrees and 950 mbar atmosphere pressure, respectively.

The rail pressures may be classified into a 300 bar rail pressure, a 600 bar rail pressure, a 900 bar rail pressure, a 1200 bar rail pressure, a 1600 bar rail pressure, and a maximum rail pressure.

The closed loop control fuel injection method may further includes establishing injection change so that it is determined whether an ET (energizing time)>500 μs condition is satisfied after the changing injection, and, if the condition is satisfied, the pilot injection close loop control is changed into the main injection close loop control, and waiting closed loop control so that when all the pilot injection and the main injection are performed, each value for the applied HRR height (H), injection amount, and injection timing is stored, such that the stored value is used as a value just before, when the closed loop control of the injector fuel injection is executed again, being executed again.

A main injection amount, which is applied during the main injection close loop control through the establishing injection change, may be determined, and the main injection amount may be calculated by integration of the HRR diagram after a gap between pilot injection timing and a section having increased ET is set by interpolation.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a configuration of an exemplary fuel injection system driven in a closed loop control manner in accordance with the present invention.

FIG. 2 is a view illustrating an exemplary relationship of a combustion starting point between a combustion pressure diagram obtained by a combustion pressure sensor of each cylinder and an HRR (Heat Release Rate) diagram derived from a combustion pressure signal in accordance with the present invention.

FIG. 3 is a view illustrating a relationship in which injection timing, an injection amount, a command signal starting point, and the like applied to the closed loop control manner are adjusted through the HRR diagram shown in FIG. 2.

FIGS. 4A and 4B are diagrams illustrating an exemplary deviation of a fuel injection amount between injectors before closed loop injection and after closed loop injection in accordance with the present invention.

FIGS. 5A and 5B are views illustrating an exemplary algorism of controlling the fuel injection system in the closed loop control manner in accordance with the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Throughout the disclosure, like reference numerals refer to like parts throughout the various figures and embodiments of the present invention.

The drawings are not necessarily to scale and in some instances, proportions may have been exaggerated in order to clearly illustrate features of the embodiments. When a first layer is referred to as being “on” a second layer or “on” a substrate, it not only refers to a case where the first layer is formed directly on the second layer or the substrate but also a case where a third layer exists between the first layer and the second layer or the substrate.

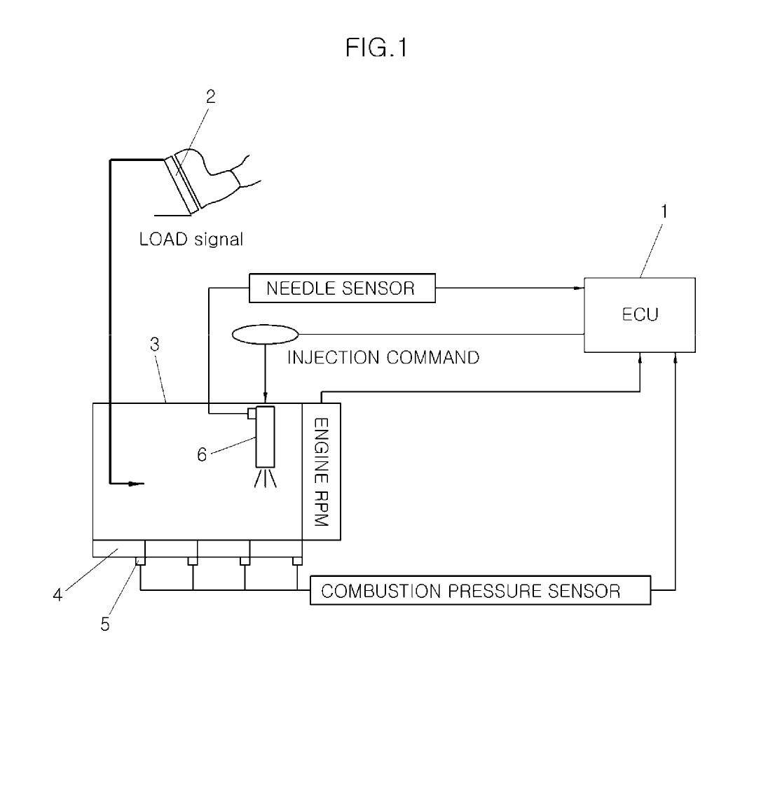

FIG. 1 shows an engine system executed in a closed loop control manner in accordance with various embodiments of the present invention. As shown in FIG. 1, the engine system is configured to transmit RPM (revolutions per minute) of an engine 3 according to a manipulation of an accelerator pedal 2, a detection signal for a fuel injection amount of an injector 6, and a detection signal from a combustion pressure sensor 5 mounted at each cylinder 4 to ECU (Electronic Control Unit) 1.

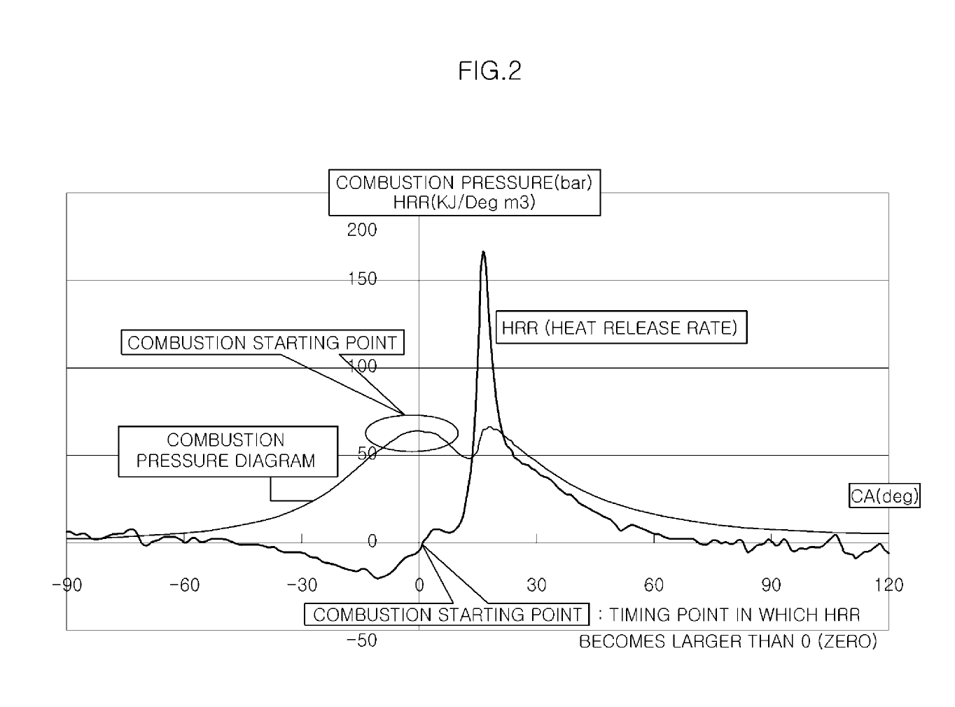

FIG. 2 shows a relationship of a combustion starting point between an HRR (Heat Release Rate) diagram and a combustion pressure diagram obtained by the combustion pressure sensor of each cylinder in accordance with various embodiments of the present invention. Referring to FIG. 2, it may be seen that the combustion starting point (target injection timing) is difficult to be obtained from the combustion pressure diagram, whereas it is obtained easily, accurately, and simply by the HRR diagram derived from a combustion pressure signal.

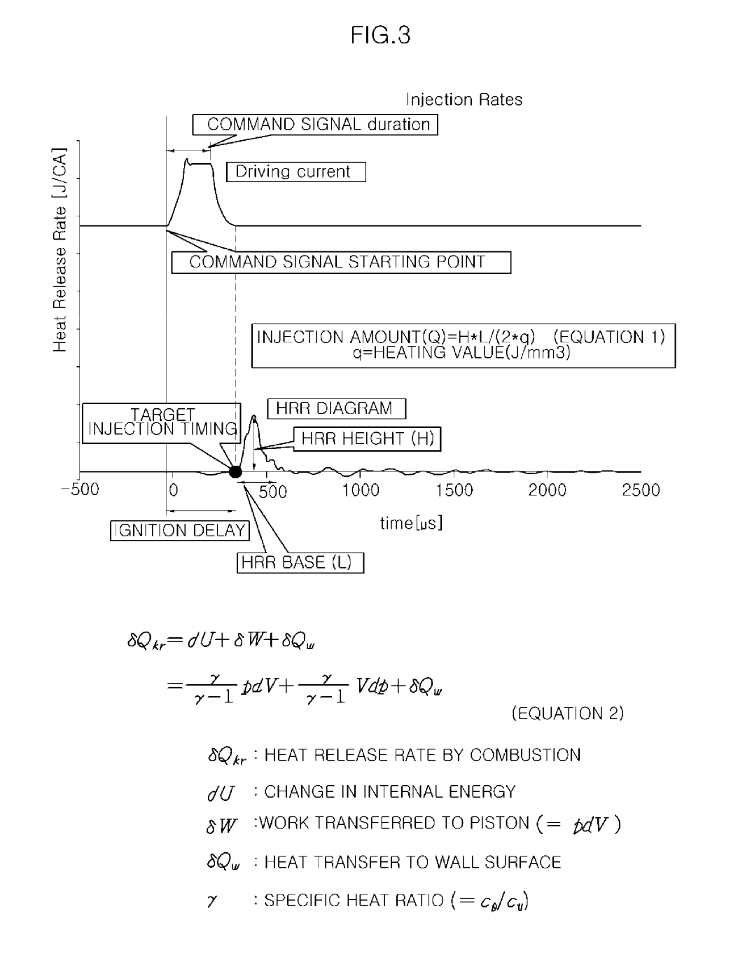

Meanwhile, FIG. 3 shows a relationship in which injection timing, an injection amount, a command signal starting point, and the like applied to the closed loop control manner in accordance with various embodiments of the present invention are obtained from the HRR diagram.

For example, the injection timing is adjusted in such a way that current injection timing is obtained from a starting point of the HRR, the injection amount is calculated by a relational equation of the injection amount (expressed by Equation (1) of FIG. 3), the relational equation being proportional to an HRR height (H) and an HRR base (L) and being inversely proportional to a heating value (q), the calculated injection amount is compared with a current injection amount so as to compare a difference therebetween with a target injection amount, and a command signal duration is adjusted so that the current injection amount becomes the target injection amount.

Also, the injection amount is adjusted in such a way that the HRR height (H) is measured, the measured HRR height (H) is compared with an HRR target height (H) so as to determine whether there is a difference therebetween, and if there is the difference, the HRR height (H) is adjusted by increasing or decreasing rail pressures by the amount of difference.

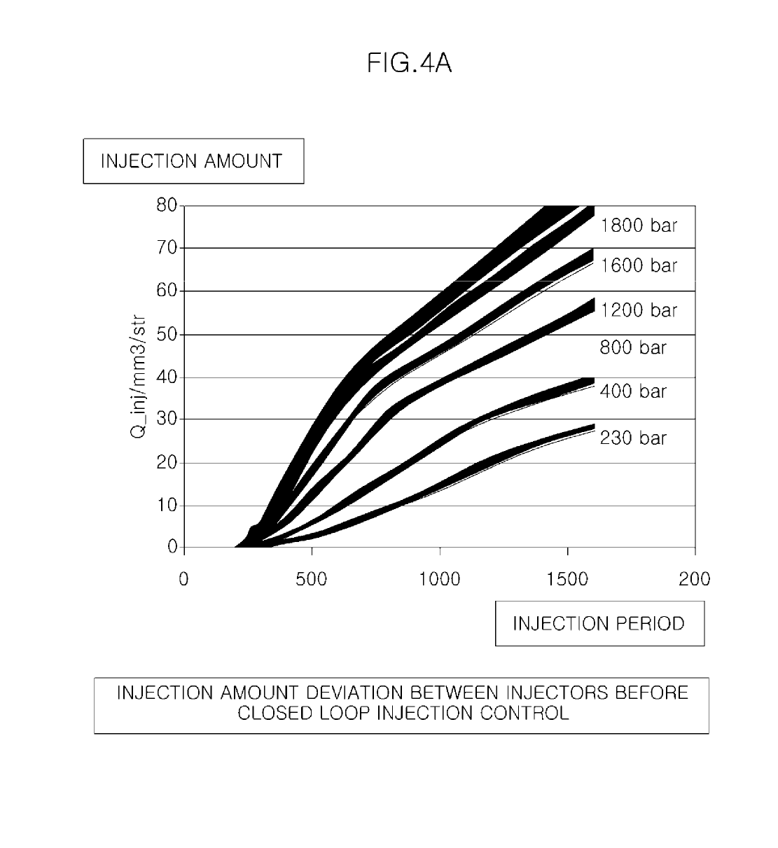

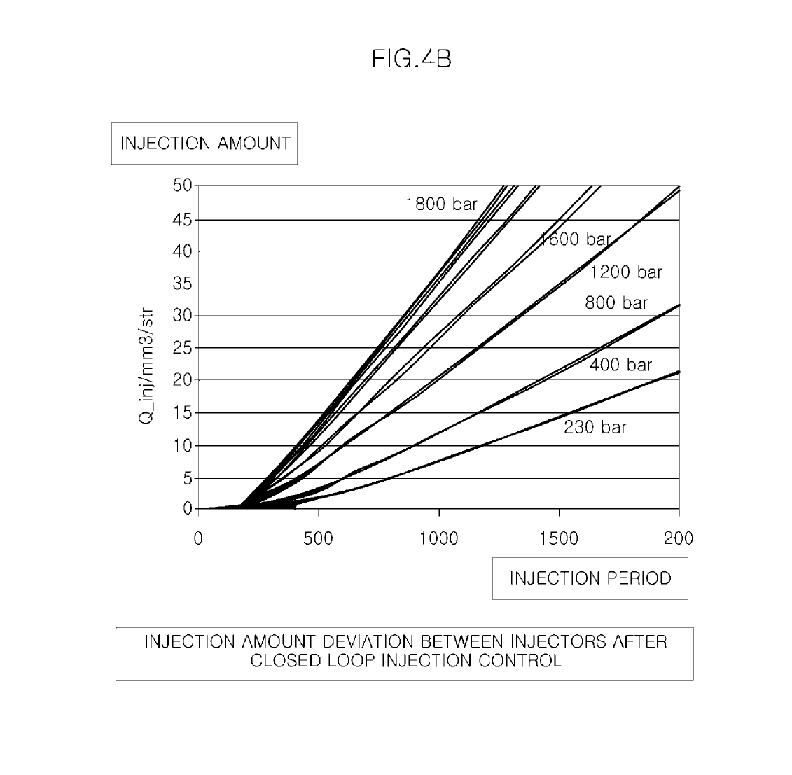

By adjusting the injection amount as described above, it may be possible to calibrate a diameter change of an injector nozzle hole caused due to an initial production deviation of the injector nozzle hole and aging of an injector nozzle. This may be identified by results before the deviation adjustment of the injection amount shown in FIG. 4(a) and after the deviation adjustment of the injection amount shown in FIG. 4(b).

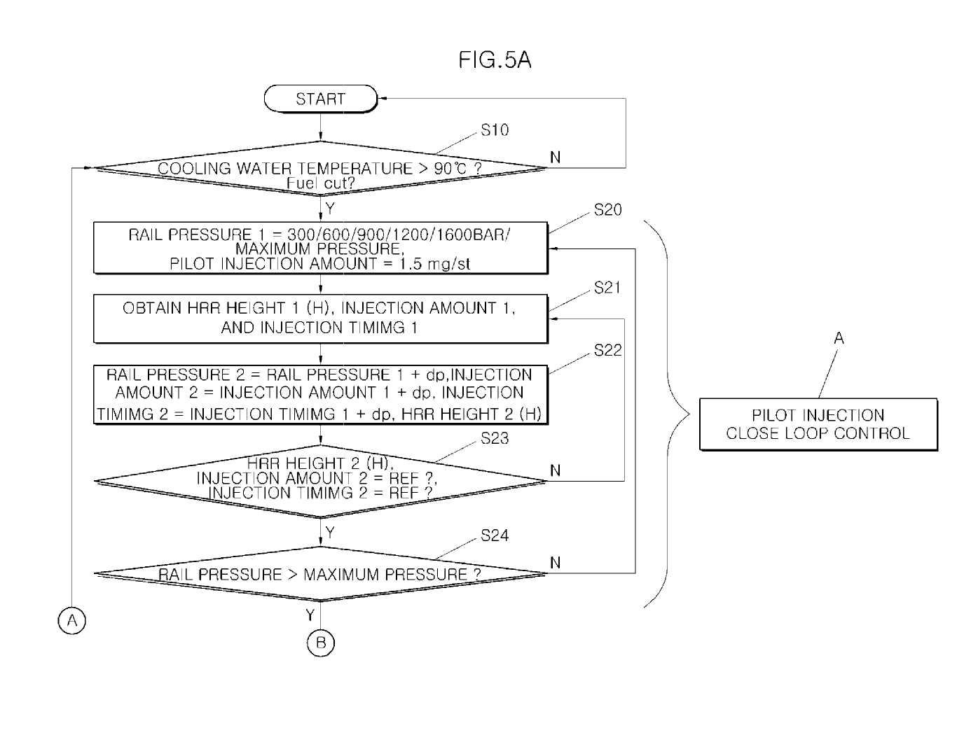

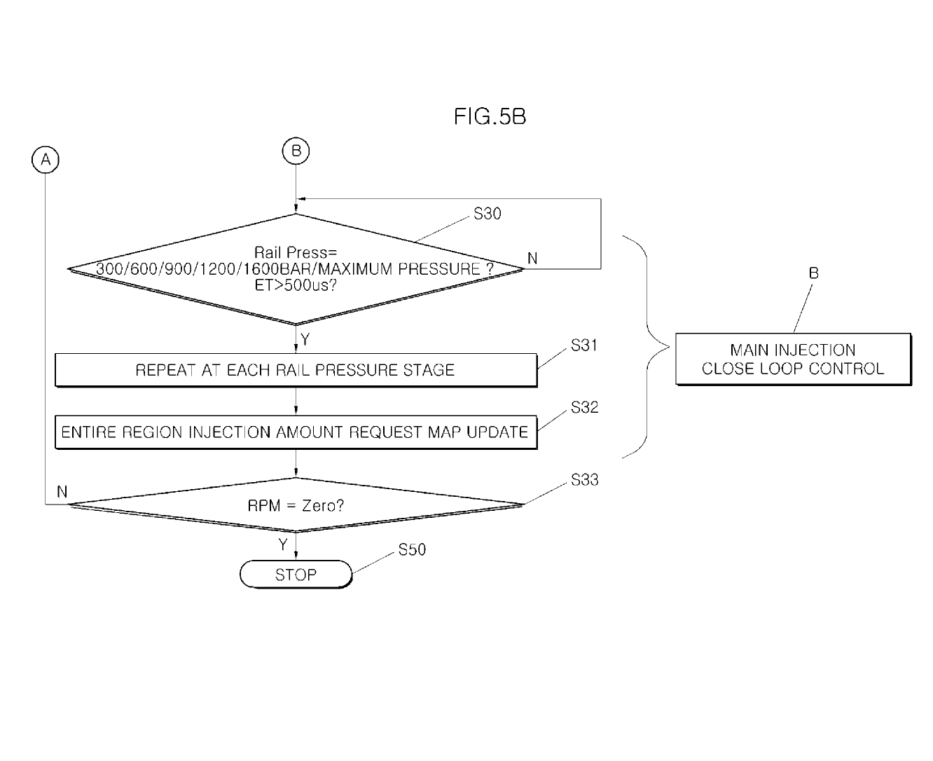

Meanwhile, FIGS. 5A and 5B show an algorism of controlling a fuel injection system in the closed loop control manner in accordance with various embodiments of the present invention.

As shown in FIGS. 5A and 5B, the algorism is embodied in such a way that execution conditions are first determined, if the conditions are satisfied, closed loop control is executed in which pilot injection close loop control (A) and main injection close loop control (B) are sequentially realized, and an injection amount request map for an entire region is updated after the completion of the pilot injection close loop control (A) and the main injection close loop control (B).

Step S10 refers to an execution condition determination step of checking conditions for executing the closed loop control after the engine is driven. This is to consistently compare target values.

In this case, the conditions to be checked are fuel cut and warm-up of the engine. The warm-up refers to a state in which a cooling water temperature of the engine is above 90 degrees or more, the fuel cut refers to a function generated during coast driving such as deceleration driving or descending driving on a slope, and it is assumed that air temperature and air pressure are above 20° C. and 950 mbar atmosphere pressure, respectively.

At step S10, if all the conditions are satisfied, the closed loop control is executed. In the closed loop control, after the pilot injection close loop control (A) is first executed according to steps S20 to S24, the main injection close loop control (B) is executed according to steps S30 and S31.

Hereinafter, the pilot injection close loop control (A) is referred to as PICLC (A), whereas the main injection close loop control (B) is referred to as MICLC (B).

S20 refers to a step in which the PICLC (A) starts. At step S20, the combustion pressure diagram is calculated by information detected from the combustion pressure sensor after a pilot fuel amount of 1.5 mg/st is injected, and the HRR diagram is produced by being derived from the combustion pressure signal.

The combustion pressure diagram is calculated according to various rail pressures. For example, the rail pressures are classified into six stages of rail pressures such as a 300 bar rail pressure, a 600 bar rail pressure, a 900 bar rail pressure, a 1200 bar rail pressure, a 1600 bar rail pressure, and a maximum rail pressure, and the combustion pressure diagram is calculated for each of the rail pressures.

The six stages of rail pressures are referred to as a rail pressure 1.

Step S21 refers to a step in which the HRR height (H), the injection amount, and the injection timing are calculated according to pilot conditions, which are respectively calculated for the six stages of rail pressures.

In the injection timing of the pilot conditions, a pilot injection timing set value for each of the six stages of rail pressures is applied to entire ET (energizing time) injection timing. This is because pilot ignition delay is also applied to main ignition delay since the injection timing is related to an initial fuel amount.

In the rail pressure of the pilot conditions, a pilot rail pressure set value for each of the six stages of rail pressures is applied to an entire ET rail pressure. This is because the rail pressure of the pilot conditions is applied to be entirely expanded due to the closed loop control related to aging such as coking of the injector nozzle hole.

In the injection amount of the pilot conditions, a pilot set value for each of the six stages of rail pressures is applied in proportion to an entire ET. For example, when a pilot fuel amount set value is changed from 1.5 mg/st to 1.75 mg/st (10% increase), an entire fuel amount is also changed from 50 mg/st to 55 mg/st (10% increase).

However, when the pilot fuel amount for each of the six stages of rail pressures is updated, a fuel amount, which is additionally calculated at a vehicle driving section having a large main fuel amount rate (ET>500 μs), should be applied to the ET. For this reason, the set value between the pilot and the section having increased ET is calculated by interpolation, and the main fuel amount is calculated by integration of the HRR diagram derived from the combustion pressure signal. As described above, when the update of the main fuel amount is completed, the update of the closed loop for the entire section is completed.

From this, an injection amount 1 and injection timing 1 are calculated, and an HRR height 1 (H) is obtained by being sensed though the HRR diagram. At such a step, a final rail pressure, an injection amount, and injection timing, which are detected just before the check, may be considered.

Step S22 refers to a step of calculating, under conditions considering a rail pressure 2 (rail pressure 1+dp) which is increased or decreased from the rail pressure 1, an injection amount 2 (injection amount 1+dp) which is increased or decreased from the injection amount 1 and injection timing 2 (injection timing 1+dp) which is increased or decreased from the injection timing 1, through which an increased or decreased rate for the injection amount, the injection timing, and the HRR height (H) are calculated.

From this, the injection amount 2 and the injection timing 2 are calculated, and an HRR height 2 (H) is calculated.

Step S23 refers to a step of determining whether the HRR height 2 (H), the injection amount 2, and the injection timing 2 correspond to reference values (ref) according to the engine RPM and an engine load. From this, the PICLC (A) is realized to correspond to the target values by repeatedly performing processes in which the HRR height (H) is calibrated to correspond to an HRR height reference value (ref), the injection amount is calibrated to correspond to an injection amount reference value (ref), and the injection timing is calibrated to correspond to an injection timing reference value (ref).

Such calibration is compared with the reference values (ref) so as to be increased when the compared values are small or be decreased when the same are large.

S24 refers to a step of determining whether the PICLC (A) need be continuously realized. For this reason, it is checked whether each of the rail pressures exceeds the maximum rail pressure.

At step S24, if the rail pressure does not exceed the maximum rail pressure, the process is returned to step S20 so that the PICLC (A) is continuously realized, whereas if the rail pressure exceeds the maximum rail pressure, the process proceeds to step S30 so that the MICLC (B) is realized.

The MICLC (B) means the main injection close loop control (B).

S30 refers to a step of checking again whether the execution conditions of the MICLC (B) are satisfied before entry into the MICLC (B). For this reason, the rail pressures are classified into the six stages of rail pressures such as the 300 bar rail pressure, the 600 bar rail pressure, the 900 bar rail pressure, the 1200 bar rail pressure, the 1600 bar rail pressure, and the maximum rail pressure, and an ET>500 μs condition is applied to the ET.

Here, the ET>500 μs condition should be determined because the additionally calculated fuel amount is applied since the main fuel amount ET rate of the entire ET is increased from the ET>500 μs.

S31 refers to a step of executing the MICLC (B) with the satisfaction of the ET>500 μs. The MICLC (B) is applied and executed to each of the 300 bar rail pressure, the 600 bar rail pressure, the 900 bar rail pressure, the 1200 bar rail pressure, the 1600 bar rail pressure, and the maximum rail pressure. The MICLC (B) is executed in the same manner as the PICLC (A) described at steps S20 to S23.

Step S40 refers to a step of injection amount request map update. This stores the injection amount, the injection timing, and the HRR height (H), which are respectively values of the PICLC (A) and the MICLC (B) respectively applied and executed to all the rail pressures (300 bar rail pressure/600 bar rail pressure/900 bar rail pressure/1200 bar rail pressure/1600 bar rail pressure/maximum rail pressure), thereby enabling the values just before, when the stored injection amount, injection timing, and HRR height (H) are executed again, being executed again to be used at the PICLC (A) and the MICLC (B).

Step S50 refers to a step of determining whether the engine is stopped by checking the engine RPM. If the engine RPM is indicated by 0 (zero), the closed loop control is stopped because of a case in which a vehicle is not driven.

On the other hand, if the engine RPM is not indicated by 0 (zero), the process is returned to step S10. Accordingly, the closed loop control is repeated again from first.

As described above, in accordance with the closed loop control fuel injection method of the various embodiments, the injection amount and the injection timing are obtained, in such a way that the HRR is calculated from the combustion pressure signal of the combustion pressure sensor after the related pilot fuel amount is injected in a state in which the engine is warmed up, and adjusted according to the command values, and thus the method may remove inaccuracy of the closed loop calibration and risks due to the excess of the EM control caused when simply using the combustion pressure diagram, through the predefined stable conditions.

In accordance with various embodiments of the present invention, it may be possible to measure an HRR (Heat Release Rate), injection timing, and an injection amount through predefined stable conditions, through which closed loop injection control is performed, thereby increasing accuracy of closed loop calibration, and particularly removing risks due to the excess of EM control.

Also, in accordance with various embodiments of the present invention, a fuel injection timing point is adjusted in the closed loop using a HRR diagram, thereby removing problems caused when using a combustion pressure diagram having complexity of calculation and significant errors in calculation, and particularly removing risks due to the excess of EM control caused by a problem of exceeding EM control since it is difficult to be injected in the closed loop control manner in a vehicle transient state.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A closed loop control fuel injection method comprising:
performing closed loop control of injector fuel injection classified into pilot injection and main injection if it is determined that an engine is a warm-up state and a fuel cut state, wherein the performing closed loop control of injector fuel injection comprises:
performing the pilot injection wherein a fuel amount related to the pilot injection of the fuel injection is injected, an HRR (Heat Release Rate) together with a combustion pressure diagram are calculated by a combustion pressure signal detected from a combustion pressure sensor in a state of classifying rail pressures into a plurality of stages, an HRR height (H), an injection amount, and injection timing, which are obtained from the HRR, are compared with target values, and the HRR height (H), the injection amount, and the injection timing are controlled to be increased or decreased according to the target values; and
performing the main injection, when the conditions of the pilot injection are released, wherein an HRR together with a combustion pressure diagram are calculated by a combustion pressure signal detected from a combustion pressure sensor in a state of classifying rail pressures into a plurality of stages, an HRR height (H), an injection amount, and injection timing, which are obtained from the HRR, are compared with target values, and the HRR height (H), the injection amount, and the injection timing are controlled to be increased or decreased according to the target values.

2. The closed loop control fuel injection method of claim 1, wherein when all the pilot injection and the main injection are performed, each value for the HRR height (H), the injection amount, and the injection timing is stored so that the stored value is used as a value just before, when the closed loop control of the injector fuel injection is executed again, being executed again.

3. The closed loop control fuel injection method of claim 1, wherein the warm-up state of the engine is a case in which a cooling water temperature of the engine is above 90 degrees, the fuel cut is generated during coast driving, and air temperature and air pressure are above 20 degrees and 950 mbar atmosphere pressure, respectively.

4. The closed loop control fuel injection method of claim 1, wherein the rail pressures are classified into a 300 bar rail pressure, a 600 bar rail pressure, a 900 bar rail pressure, a 1200 bar rail pressure, a 1600 bar rail pressure, and a maximum rail pressure.

5. A closed loop control fuel injection method comprising:
identifying conditions so that closed loop control conditions of injector fuel injection classified into pilot injection and main injection are determined in a state in which an engine is a warm-up state and a fuel cut state;
preparing pilot control so that, if the closed loop control conditions are satisfied, a fuel amount related to the pilot injection is injected, a combustion pressure diagram is calculated from a combustion pressure signal of a combustion pressure sensor with respect to a first rail pressure classified into a plurality of stages, an HRR diagram is derived from the combustion pressure signal, and a first HRR height (H), a first injection amount, and a first injection timing are calculated from the same;
determining pilot control so that, under the same conditions, a second rail pressure, a second HRR height, a second injection amount, and second injection timing, which are increased or decreased values of the first rail pressure, the first HRR height (H), the first injection amount, and the first injection timing, respectively, are calculated, and the values are compared with reference values (ref) according to engine RPM and an engine load;
executing pilot control so that the second HRR height, the second injection amount, and the second injection timing are increased or decreased and calibrated to correspond to the reference values (ref) so as to determine target values, and the closed loop control is performed according to the target values;
changing injection so that if rail pressures checked when pilot injection close loop control is executed exceed a set maximum rail pressure, the pilot injection is stopped and main injection close loop control is executed;
preparing main control so that, if the main injection close loop control is executed, a fuel amount related to the main injection is injected, a combustion pressure diagram is calculated from a combustion pressure signal of a combustion pressure sensor with respect to a new first rail pressure classified into a plurality of stages, an HRR diagram is derived from the combustion pressure signal, and a new first HRR height (H), a new first injection amount, and new first injection timing are calculated from the same;
determining main control so that, under the same conditions, a new second rail pressure, a new second HRR height, a new second injection amount, and new second injection timing, which are increased or decreased values of the new first rail pressure, the new first HRR height (H), the new first injection amount, and the new first injection timing, respectively, are calculated, and the values are compared with new reference values (ref) according to engine RPM and an engine load; and
executing main control so that the new second HRR height, the new second injection amount, and the new second injection timing are increased or decreased and calibrated to correspond to the new reference values (ref) so as to determine target values, and the closed loop control is performed according to the target values.

6. The closed loop control fuel injection method of claim 5, wherein the warm-up state of the engine is a case in which a cooling water temperature of the engine is above 90 degrees, the fuel cut is generated during coast driving, and air temperature and air pressure are above 20 degrees and 950 mbar atmosphere pressure, respectively.

7. The closed loop control fuel injection method of claim 5, wherein the rail pressures are classified into a 300 bar rail pressure, a 600 bar rail pressure, a 900 bar rail pressure, a 1200 bar rail pressure, a 1600 bar rail pressure, and a maximum rail pressure.

8. The closed loop control fuel injection method of claim 5, further comprising:
establishing injection change so that it is determined whether an ET (energizing time)>500 μs condition is satisfied after the changing injection, and, if the condition is satisfied, the pilot injection close loop control is changed into the main injection close loop control; and
waiting closed loop control so that when all the pilot injection and the main injection are performed, each value for the applied HRR height (H), injection amount, and injection timing is stored, wherein the stored value is used as a value just before, when the closed loop control of the injector fuel injection is executed again, being executed again.

9. The closed loop control fuel injection method of claim 8, wherein a main injection amount, which is applied during the main injection close loop control through the establishing injection change, is determined, and the main injection amount is calculated by integration of the HRR diagram after a gap between pilot injection timing and a section having increased ET is set by interpolation.
